(19) United States
(12) Patent Application Publication
(10) Pub. No.: US 2012/0186379 A1
(43) Pub. Date: Jul. 26, 2012

(54) INDUSTRIAL ROBOT

(75) Inventor: Hideto Miyamoto, Toyama (JP)

(73) Assignee: NACHI-FUJIKOSHI CORP., Toyama-shi (JP)

(21) Appl. No.: 13/347,173

(22) Filed: Jan. 10, 2012

(30) Foreign Application Priority Data
Jan. 21, 2011 (JP) 2011-010957

(51) Int. Cl. B25J 18/00

(52) U.S. Cl. 74/490.01; 901/22; 901/27

(57) ABSTRACT

An industrial robot comprises an arm which includes a proximal portion rotatably supported on a horizontal rotation shaft of a frame in a cantilever state, a cylindrical case portion formed from the proximal portion side to a distal end of the arm to have an opening portion on the proximal portion side, and an arm distal end portion. The industrial robot also comprises a balancer device which includes a rod, and a cylinder 3a in which the rod is reciprocated. An engagement portion at a distal end of the rod, and a rear end of the cylinder are rotatably supported between a pair of first support portions of the frame, and between a pair of second support portions inside the cylindrical case portion, respectively, so that the cylindrical case portion and the balancer device do not interfere with each other in an extent of rotation of the arm.

### BACKGROUND OF THE INVENTION

1. Field of the Invention

The present invention relates to an industrial robot having a balancer device for reducing a load acting on a motor and a speed reducer for driving an arm.

2. Description of Related Art

In order to hold the mass of an arm and the mass of an end effector mounted on a distal end of a robot only by motor power, a motor and a speed reducer with large capacity are required. Particularly, there is the problem that a moment load due to gravity becomes large toward a base of an axis, and therefore a motor and a speed reducer with large capacity are required.

In JP-A-11-28690, a spring-type balancer device is mounted on a side surface of an arm, so that one end is supported on an upper side of an arm rotation shaft and the other end is supported on an arm side. In FIGS. 4 and 5 of JP-A-2009-262297, a spring-type balancer device mounted behind an arm is disclosed. Further, JP-A-10-138189 discloses a balancer device having a hydraulic cylinder and a gas compression chamber (an accumulator). Furthermore, JP-A-05-329792 discloses a balancer device using a fluid-operated actuator, and JP-A-2009-262297 and JP-A-2009-50951 disclose an electrically-driven balancer device.

However, since there is the problem that, in the case of JP-A-11-28690 and JP-A-2009-262297, a spring case becomes thick and long in order to obtain a larger generative force, the width of a robot increases if the balancer device is mounted on the arm side surface, and a turning interference radius of the robot on a back side increases if the balancer device is mounted behind the arm. Further, since a plurality of springs are used and the number of components is thus also increased, there is also the problem that the balancer device is heavy, and it takes time to assemble the balancer device, or the cost increases. Furthermore, the structure becomes simple when the spring is used on a compressed side such that the generative force increases as a stroke of the balancer device is extended, however, it is necessary to this end to arrange support portions of both ends of the balancer device on the same side with respect to a rotation axis of the arm. Thus, there is the problem that the length of the balancer device increases, so that the length of the arm increases, or the turning interference radius of the robot on the back side further becomes large.

Since JP-A-10-138189 uses compressed air, there is an advantage that the diameter of a cylinder portion becomes small and the entire length thereof becomes short as compared to the spring-type balancer device, however, since a gas compression chamber is separately required, the entire size of the balancer device increases. Further, since the balancer device is used such that the generative force is increased as the stroke is extended as with the spring-type balancer device, it is necessary to fill a rod side of the cylinder with oil, and therefore the diameter of the cylinder becomes large as compared to the case where an opposite side of the cylinder to the rod is filled with oil, in order to obtain the same generative force by the same pressure.

Furthermore, in JP-A-11-28690, JP-A-2009-262297, JP-A-10-138189, and JP-A-05-329792, one end of the balancer device is supported on the upper side of the arm rotation shaft, and the other end is supported on the arm side. In the case of JP-A-2009-50951, since a backward projection requires a large space, the balancer device can not have a large length or stroke. Accordingly, in the case of JP-Y2-06-41824, the balancer device is arranged between arms composed of a pair of members, such that a tip end of a rod of the balancer device is rotatably supported between a pair of first support portions arranged in front of and below a frame, and a rear end of a cylinder is rotatably supported between a pair of second support portions arranged between the pair of arms.

### BRIEF SUMMARY OF THE INVENTION

In JP-Y2-06-41824, however, since the balancer device is arranged between the pair of arm bodies, there is the problem that the balancer device interferes with an arm rotation shaft, and therefore can be rotated only toward the front side. Accordingly, it is possible to adopt a cantilever arm as disclosed in JP-A-11-28690, however, the strength of the arm is decreased in this case. Further, there is the problem that the balancer device also interferes with the frame since the rod tip end is arranged below the frame.

In view of the above problems, it is an object of the present invention to provide a compact industrial robot in which a stroke of a balancer device can be long, and the balancer device can avoid interference with a frame and have a large extent of rotation of an arm while ensuring the strength of the arm.

According to the present invention, the above object is achieved by providing an industrial robot including an arm rotatably supported about a horizontal rotation shaft provided on a frame, and a balancer device for reducing a load of the arm, wherein the arm has a proximal portion rotatably supported on the horizontal rotation shaft in a cantilever state, a cylindrical case portion opened on the proximal portion side and formed from the proximal portion side to a distal end of the arm, and an arm distal end portion, the balancer device has a rod having an engagement portion at a distal end thereof, and a cylinder into and out of which the rod is pulled, the engagement portion at the distal end of the rod is rotatably supported between a pair of first support portions provided on the frame on a lower side of the horizontal rotation shaft, a rear end of the cylinder on an opposite side to the rod is rotatably supported between a pair of second support portions provided inside the cylindrical case portion, and the cylindrical case portion and the balancer device are arranged so as not to interfere with each other in an extent of rotation of the arm, including both sides of the horizontal rotation shaft.

That is, to make the arm in a cantilever state, the proximal portion and the distal end portion are provided at both ends of the arm, so that the strength around the rotation shaft is ensured. This is similar to a conventional case. Further, the cylindrical case portion opened on the proximal portion side and formed to the distal end of the arm, i.e., the cylindrical case portion having a cylindrical integral shape, and more preferably, a monocoque structure is provided to ensure the strength. Furthermore, the cylinder side of the balancer device is rotatably supported between the pair of second support portions provided inside the cylindrical case portion, so that the support strength of the balancer device is ensured. Furthermore, the engagement portion of the balancer device at the distal end of the rod is rotatably supported between the pair of first support portions provided on the frame on the lower side from the horizontal rotation shaft, and the cylindrical case portion and the balancer device are arranged so as not to interfere with each other in the extent of rotation of the arm including both sides of the horizontal rotation shaft, so that the arm is made rotatable on both sides of the horizontal rotation shaft. The opening portion is formed so as to become wider toward the proximal portion side.

In an invention according to claim 2, a compressible fluid is charged in the balancer device in a direction in which a reaction force increases as the rod is pulled in. Accordingly, the load of the arm is reduced in a compression direction. Meanwhile, in an invention according to claim 3, a compressible fluid is charged in the balancer device in a direction in which a reaction force increases as the rod is pulled out, and the industrial robot according to claim 1 is installed upside down. Accordingly, the frame can be fixed to a ceiling to enable operation in a downward direction.

Further, in an invention according to claim 4, a rotation center of the first support portions, the horizontal rotation shaft, a rotation center of the second support portions, and a gravity center of the arm are in such a relationship as to be aligned along a straight line when the arm is at an upright position. Accordingly, the length of the balancer device becomes maximum when a load of the arm is small, so that the length of the balancer device becomes short to increase the reaction force as the load increases by the rotation of the arm.

The industrial robot of the invention can ensure a long stroke of the balancer device, avoid interference between the arm and the frame, and increase an extent of rotation of the arm while ensuring the strength of the arm, by making the arm in a cantilever state, providing the cylindrical case portion opened on the proximal portion side and formed toward the distal end of the arm between both ends of the arm, rotatably supporting the balancer device on the cylinder side between the second support portions inside the cylindrical case portion, rotatably supporting the engagement portion of the balancer device at the distal end of the rod between the first support portions on the frame on the lower side of the horizontal rotation shaft, so that the cylindrical case portion and the balancer device do not to interfere with each other in the arm rotation extent including both sides of the horizontal rotation shaft, and thereby the arm is rotatable on both sides of the horizontal rotation shaft.

Further, since the cylinder portion of the balancer device can be incorporated in the arm without increasing the thickness of the entire arm, it becomes possible to provide the compact industrial robot in which the turning interference radius on the front and rear sides of the robot is decreased and the width is not increased. Since the first support portions on the frame side are located on an upper surface of the frame, the structure is simple, and thus the work such as assembling and disassembling is easy. A proximal portion cover portion may be provided so as to extend downward from the opening portion of the cylindrical case portion on the opposite side to the rotation shaft, and cover the entire balancer device including the rod portion, so as to improve the appearance, provide a protecting cover, or increase the case strength.

In the invention according to claim 2, since the reaction force of the balancer device increases as the rod is pulled in, so that the load of the arm is reduced in the compression direction, the balancer device can be used by “pushing”, and thus the compressible fluid can be used. By charging the compressible fluid on the opposite side to the rod, the diameter of the cylinder can be decreased, and further, the thickness of the arm can be decreased. Since a load is applied to the first support portions on the frame side in a pushing direction, the support portions can be reduced in size as compared to the case where a load is applied in a pulling direction.

In the invention according to claim 3, since the compressible fluid is charged in a pulling direction such that the reaction force of the balancer device increases as the rod is pulled out, so as to enable operation in a downward direction, the balancer device can be used as a device for reducing a load of an arm of a ceiling-suspended robot which is installed upside down only by replacing the balancer device with a balancer device of “pulling” type in which the compressible fluid is charged on the rod side.

In the invention according to claim 4, since the length of the balancer device is set to be maximum at a position where the rotation center of the first support portions, the horizontal rotation shaft, the rotation center of the second support portions, and the gravity center of the arm are aligned along the straight line when the arm is at the upright position, the length of the balancer device can be increased, and a sufficient space volume for the compressible fluid can be ensured in the cylinder even when the distance between the support portions is smallest. Further, a rapid pressure rise can be suppressed even without an auxiliary tank or the like. In this case, the compressible fluid can be prevented from leaking out, and the operating life of a seal gasket can be improved.

### BRIEF DESCRIPTION OF THE SEVERAL VIEWS OF THE DRAWING

FIG. 1B is a partial external view of an industrial robot according to an embodiment of the present invention, and FIG. 1A is a view taken in the direction of arrow Y in FIG. 1B;

FIG. 2 is a partial sectional view illustrating a section taken along line X-X in FIG. 1A;

FIG. 3A is an operational view illustrating the operation of an arm and a balancer device of the industrial robot according to the embodiment of the present invention, in a state where the arm is rotated toward a front end;

FIG. 3B is an operational view illustrating the operation of the arm and the balancer device of the industrial robot according to the embodiment of the present invention, in a state where the arm is rotated toward a rear end; and

FIG. 4 is a partial sectional view of a balancer device for a ceiling-suspended robot according to another embodiment of the present invention.

### DETAILED DESCRIPTION OF THE INVENTION

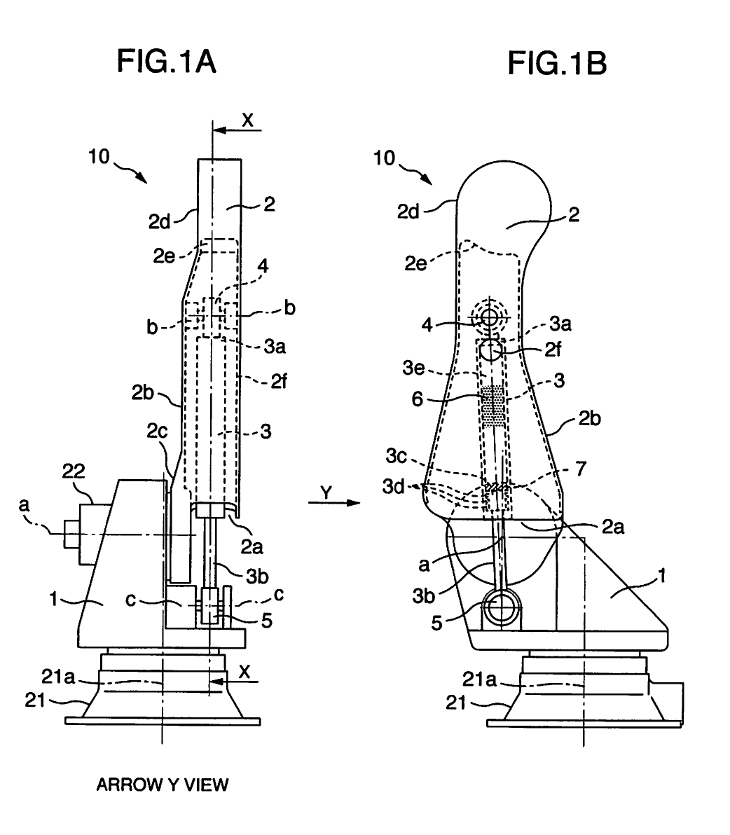

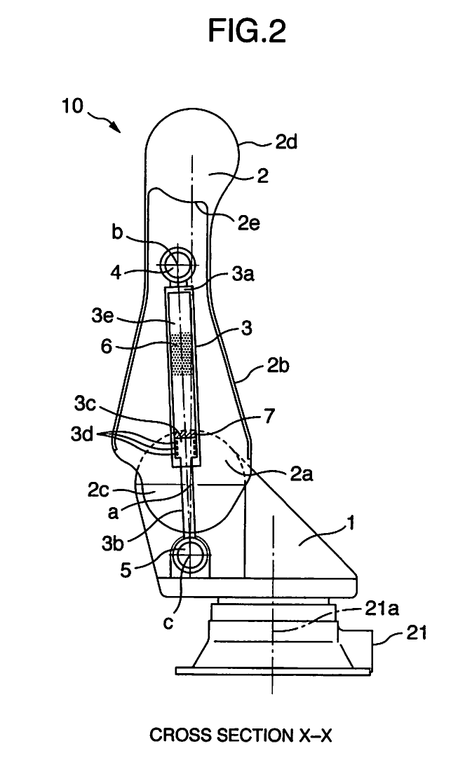

An embodiment of the present invention will be described with reference to the drawings. FIG. 1B is a partial external view of an industrial robot according to the embodiment of the present invention, and FIG. 1A is a view taken in the direction of arrow Y in FIG. 1B. FIG. 2 is a partial sectional view illustrating a section taken along line X-X in FIG. 1A. As shown in FIGS. 1 and 2, an industrial robot 10 according to the present invention includes a frame 1 that is rotatable about a swivel axis 21a of a base 21, an arm 2 that is supported rotatably (movably in a tilting manner) about a horizontal rotation shaft a horizontally provided on the frame, and a balancer device 3 that reduces a load on the arm. A second arm, a wrist or the like (not shown) are further provided in the arm 2, to constitute a multi joint industrial robot. However, the above elements are the same as those of a conventional case, and the description thereof is thus omitted.

The arm 2 includes a proximal portion 2c rotatably supported on the horizontal rotation shaft a in a cantilever state, a cylindrical case portion 2b following the proximal portion, and an arm distal end portion 2d connected to a bottom portion (an end opposite to an opening) 2e of the cylindrical case portion. A rotation shaft of the second arm (not shown) is provided at the arm distal end portion. A motor with a speed reducer 22 is mounted to the horizontal rotation shaft a in the frame 1 on the opposite side to the arm. The arm 2 is thereby made rotatable. The cylindrical case portion 2b forms a thin-walled cylindrical shape whose upper side in the drawings is closed. The entire arm including the proximal portion 2c and the distal end portion 2d has a cast integral structure. The strength of the arm 2 is thereby improved. An opening portion 2a is provided in the cylindrical case portion 2b on the proximal portion side as the lower side in the drawings, so that the cylindrical case portion opens on the lower side. A cover portion may be formed to extend from the opening portion 2a on the opposite side to the frame so as to cover a rod portion.

The balancer device 3 connecting the arm 2 and the frame 1 includes a rod 3b having an engagement portion 5 at a distal end thereof, and a cylinder 3a into and out of which the rod is pulled via a piston 3c. The engagement portion 5 at the distal end of the rod is rotatably supported between a pair of first support portions c and c provided on the frame on the lower side from the horizontal rotation shaft a. A rear end 4 of the cylinder 3a on the opposite side to the rod is rotatably supported between a pair of second support portions b and b provided inside the cylindrical case portion 2b. As shown in the drawings, the rotation center of the first support portions, the horizontal rotation shaft, the rotation center of the second support portions, and the gravity center of the arm are aligned in a straight line when the arm 2 is at an upright position. The position where the above elements are aligned in the straight line may not necessarily be the upright position.

The piston 3c provided on the rod 3b can slide within the cylinder 3a, and a compressible fluid 6 is charged in a space between the piston and the cylinder on the opposite side to the rod. The cylindrical case portion on the opening portion 2a side is formed so as to become wider toward its end as viewed in the axial direction of the horizontal rotation shaft a. The cylindrical case portion 2b and the balancer device 3 are thereby prevented from interfering with each other in an extent of rotation of the arm including both sides of the horizontal rotation shaft. The balancer device 3 is also mounted such that the cylinder 3a is always accommodated within the cylindrical case portion 2b regardless of the operating position of the arm 2.

A self-aligning roller bearing (not shown) is mounted at each of the first support portion c and the second support portion b. The balancer device 3 is thereby allowed to swing about an axis perpendicular to rotation axes b and c as the first and second supports. The arm 2 has a window 2f for facilitating inspection of the pressure of the balancer device 3 and supply of the compressible fluid. The maintenance property is thereby improved.

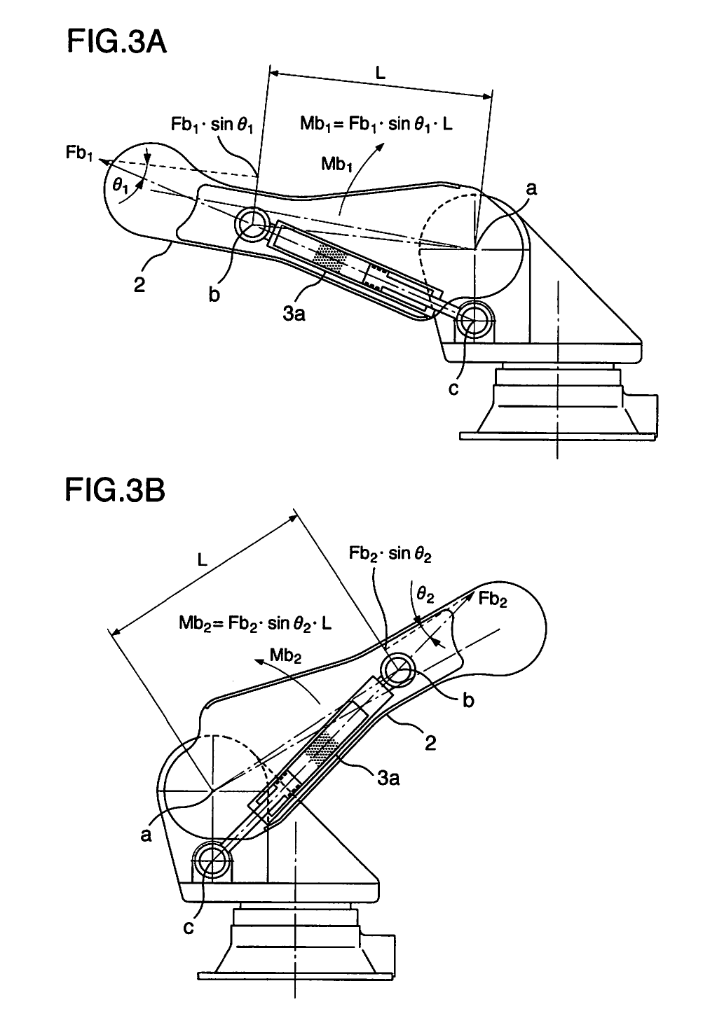

FIGS. 3A and 3B are operational views illustrating the operation of the arm and the balancer device of the robot. FIG. 3A is an operational view illustrating a state in which the arm is rotated toward a front end, and FIG. 3B is an operational view illustrating a state in which the arm is rotated toward a rear end. As shown in FIGS. 3A and 3B, the cylinder 3a is always accommodated within the arm 2 even when the position of the arm 2 is changed. Thus, the balancer device 3 does not possibly interfere with peripheral devices of the robot. The robot is compact with no projection on the rear side and the front side. In the balancer device 3, as the distance between the first support portion c and the second support portion b is smaller, the compressible fluid 6 is compressed to generate a larger repulsive force. A rotation moment Mb1 by a reaction force is expressed as follows, and therefore, as θ1 becomes larger, the repulsive force is also increased.

Mb1=Fb1×sin θ1×L

where the reaction force of the balancer device generated when the arm is inclined frontward as shown in FIG. 3A is represented as Fb1, the distance between the horizontal rotation shaft a and the second support portion (shaft) b is represented as L, and an open angle between the horizontal rotation shaft a and the first support portion (shaft) with respect to the second support portion (shaft) is represented as θ1.

A rotation moment Mb2 by the reaction force is expressed as follows, and therefore, in the case of θ1=θ2−0, the rotation moment by a reaction force is also 0.

Mb2=Fb2×sin θ2×L

where the reaction force of the balancer device generated when the arm is inclined rearward as shown in FIG. 3B is represented as Fb2, a distance between the horizontal rotation shaft a and the second support portion (shaft) b is represented as L, and an open angle between the horizontal rotation shaft a and the first support portion (shaft) with respect to the second support portion (shaft) is represented as θ2.

In the embodiment as described above, the length of the balancer device 3 can be increased while ensuring the strength of the arm 2. Moreover, the cylinder 3a has a much larger space 3e in the longitudinal direction than a stroke required for the piston 3c in association with the operation of the arm 2. Thus, even when the distance between the first support portion c and the second support portion b is smallest, a rapid pressure rise due to an extreme decrease in volume can be prevented. The rotation extent of the arm 2 can be also increased. Moreover, since the balancer device is used in a “pushing” state, a seal gasket is not required in the rod portion, and the risk that a seal gasket is damaged due to dust adhering to the rod is solved.

Since the rod is directed downward, the lubricant oil 6 is stacked on the piston 3c which is a sliding portion, and is therefore always supplied to a seal gasket 3d of the piston 3c. Since the lubricant oil 6 is stacked on the sliding piston and thereby always supplied to the seal gasket of the piston portion, a reduction in the operating life of the seal gasket can be prevented. As described above, the compact and low-cost industrial robot where the balancer device is incorporated in the arm can be provided.

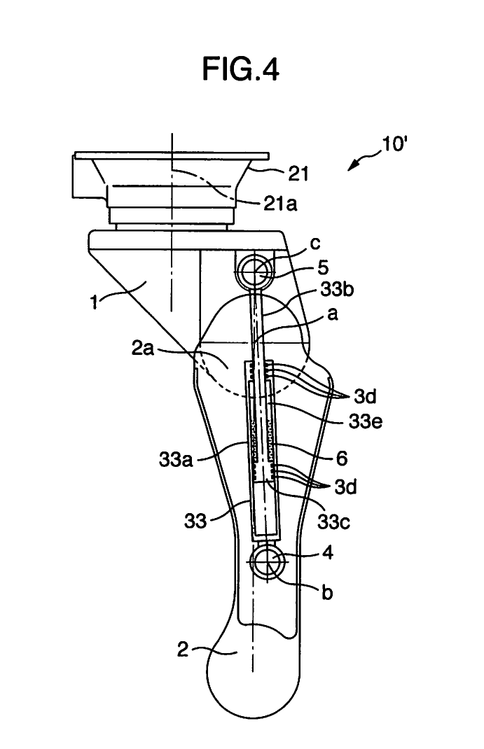

Next, another embodiment of the present invention will be described with reference to the drawings. FIG. 4 is a partial sectional view of a balancer device for a ceiling-suspended robot 10′ according to another embodiment of the present invention. As shown in FIG. 4, instead of the balancer device 3, the compressible fluid 6 is charged in a direction in which a reaction force increases as the rod is pulled out. When the robot is suspended upside down, a balancer device 33 where the compressible fluid 6 is charged in a space 33e between a cylinder 33a on a rod 33b side and a piston 33c is mounted, so that the repulsive force of the compressible fluid 6 is generated in a direction to reduce the load of the arm 2. Since the other portions are the same as those described above, the description thereof is omitted by assigning the same reference numerals thereto.

Although the embodiments of the present invention have been described above, it goes without saying that the load of the arm can be also reduced by employing a spring in the balancer device 3 and the balancer device 33 on the same side as the compressible fluid instead of the compressible fluid. Since both ends of the balancer device are located apart from the arm driving motor and the speed reducer as a heat generating source, a pressure rise caused when the compressible fluid in the cylinder is heated by heat transmission from the rod or the cylinder can be also prevented. The robot can be also reduced in mass as compared to a robot with a spring-type balancer device. Furthermore, by incorporating the balancer device which is a pressure vessel in the arm, effects of improving the safety and the like can be brought about.

1. An industrial robot comprising:
an arm rotatably supported about a horizontal rotation shaft provided on a frame; and
a balancer device for reducing a load of the arm, wherein
the arm comprises a proximal portion rotatably supported on the horizontal rotation shaft in a cantilever state, a cylindrical case portion opened on the proximal portion side and formed from the proximal portion side to a distal end of the arm, and an arm distal end portion,
the balancer device comprises a rod having an engagement portion at a distal end thereof, and a cylinder in which the rod is reciprocated,
the engagement portion at the distal end of the rod is rotatably supported between a pair of first support portions provided on the frame on a lower side of the horizontal rotation shaft,
a rear end of the cylinder on an opposite side to the rod is rotatably supported between a pair of second support portions provided inside the cylindrical case portion, and
the cylindrical case portion and the balancer device are arranged so as not to interfere with each other in an extent of rotation of the arm that includes both sides of the horizontal rotation shaft.

2. The industrial robot according to claim 1, wherein a compressible fluid is charged in the balancer device in a direction in which a reaction force increases as the rod is pulled in.

3. The industrial robot according to claim 1, wherein a compressible fluid is charged in the balancer device in a direction in which a reaction force increases as the rod is pulled out, and the industrial robot is installed upside down.

4. The industrial robot according to claim 1, wherein a rotation center of the first support portions, the horizontal rotation shaft, a rotation center of the second support portions, and a gravity center of the arm are in such a relationship as to be aligned in a straight line when the arm is in an upright position.

5. The industrial robot according to claim 2, wherein a rotation center of the first support portions, the horizontal rotation shaft, a rotation center of the second support portions, and a gravity center of the arm are in such a relationship as to be aligned in a straight line when the arm is in an upright position.

6. The industrial robot according to claim 3, wherein a rotation center of the first support portions, the horizontal rotation shaft, a rotation center of the second support portions, and a gravity center of the arm are in such a relationship as to be aligned in a straight line when the arm is in an upright position.
